(19) United States
(12) Patent Application Publication
(10) Pub. No.: US 2008/0082612 A1
(43) Pub. Date: Apr. 3, 2008

(54) METHODS HANDSET AND SYSTEM FOR DOWNLOADABLE IMS MIDDLEWARE

(75) Inventor: DANIEL J. DECLERCK, LAKE BARRINGTON, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/536,227

(22) Filed: Sep. 28, 2006

(51) Int. Cl. G06F 15/16

(52) U.S. Cl. 709/206

(57) ABSTRACT

An embodiment relates generally a method of updating. The method includes establishing a session with a network and determining a network Internet Messaging System (IMS) client of the network. The method also includes retrieving the network IMS client in response to the network IMS client not matching a current IMS client.

### FIELD

This invention relates generally to communication systems, more particularly for a downloadable Internet Messaging System (IMS) middleware.

### DESCRIPTION OF THE RELATED ART

Communication systems providing wireless communication for user equipment are known. An example of a wireless system is a mobile network. Mobile networks are commonly based on cellular technology. In cellular systems, a base transceiver station (BTS) or similar access entity services mobile user equipment such as handsets via a wireless interface between these entities. The communication on the wireless interface between the user equipment and elements of the communication network can be based on the appropriate communications protocol. The operation of a base station apparatus and other apparatus required for the communication can be controlled by one or several control entities.

One or more gateway nodes may be provided for connecting the cellular access network to other networks, for example to a public switched telephone network (PSTN) and/or other communication networks such as an IP (internet protocol) and/or other packet switched data networks. In such arrangements, the mobile communications network provides an access network enabling a user with wireless user equipment to access external networks, hosts, or services offered by specific service providers.

Some of the communication systems are enabled to offer application services such as internet protocol (IP) multimedia networks, via an IP multimedia core network subsystem (IMS). The IMS includes various network entities for the provision of multimedia services. IMS services are intended to offer, among other services, IP based packet data communication sessions between mobile user equipment. The IMS core is for ensuring that multimedia services are adequately managed. The IMS core commonly supports the session initiation protocol (SIP) as developed by the internet engineering task force (IETF). SIP is an application-layer control protocol for creating, modifying and terminating sessions with one or more participants (end points). SIP was generally developed to allow the initiation of a session between two or more end points in the Internet by making these end points aware of the session semantics. A user connected to a SIP based communication system may communicate with various entities of the communication system based on standardized SIP messages. SIP is for example defined in the IETF specification RFC 3261, which is hereby incorporated by reference.

The IETF specification RFC 3860 defines a protocol independent instant messaging IM URI scheme. Instant messaging is a means for sending small, simple messages that are delivered immediately to online users, which is incorporated by reference. Reference is also made to RFC 3861 which describes a mechanism for address resolution for instant messaging and presence services.

The service providers of the communication systems tend to promote their own IMS client for their users to be used for their application services. Accordingly, there is incompatibility between IMS clients of respective communication systems. Thus, there exists a need to ensure interoperability of IMS cores across a multitude of wireless infrastructure vendor networks. Moreover, it is advantageous to keep the network IMS core close to the handset to reduce the number of hops, to improve latency, and round trip delay.

### SUMMARY

An embodiment relates generally to a method of updating. The method includes establishing a session with a network and determining a network Internet Messaging System (IMS) client of the network. The method also includes retrieving the network IMS client in response to the network IMS client not matching a current IMS client.

Another embodiment pertains generally to a handset. The handset includes a network interface configured to receive and transmit signals from a network and a processor configured to interface with the network interface. The processor is configured to establish a session with the network and to determine a network Internet Messaging System (IMS) client of the network. The processor is also configured to retrieve the network IMS client in response to the network IMS client not matching a current IMS client for the handset.

Yet another embodiment relates generally to a system. The system includes a network configured to provide text messaging services for handsets based on a network Internet Messaging System (IMS) client within a coverage area of the network. The system also includes a mobile terminal configured to interface with the network through a network interface. The mobile terminal includes a processor configured to establish a session with the network through the network interface and determine a network IMS client of the network. The processor is also configured to retrieve the network IMS client in response to the network IMS client not matching a current IMS client for the handset.

Accordingly, user perceived interoperability within different network infrastructures may be achieved without user intervention. More specifically, a user may travel through geographical areas knowing that the mobile terminal or device of the user will have full use of application services provided by the varying service providers. Moreover, embodiments may allow infrastructure vendors and carriers more flexibility in determining IMS clients for use in certain areas and deploying network capital across their coverage footprint.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 illustrates an exemplary mobile terminal in accordance with an embodiment;

FIG. 2 illustrates an exemplary network in accordance with another embodiment; and

FIG. 3 illustrates a flow diagram executed by the mobile terminal shown in FIG. 1 in accordance with an embodiment.

### DETAILED DESCRIPTION OF EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, all types of communication systems, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Embodiments generally relate to an Internet messaging service (IMS) query client executing on a mobile terminal. More specifically, the query client may have an associated unique identification number. The query client may initially query a network for an IMS client supported by the network during a session establishment between the network and the mobile terminal. If the query client determines that the network IMS client is not the local IMS client executing on the mobile terminal, the query client may then retrieve the network IMS client. Alternatively, the mobile terminal may be configured to store multiple IMS clients from various networks. As part of the query, the query client may compare the stored IMS clients to see if any match the required network IMS client. If there is no match, the query client may be configured to retrieve the network IMS client and discard the stored IMS client with the longest period of inactivity.

In accordance with various embodiments, the query client may monitor whether the mobile terminal enters a non-home network. The query client may then determine whether the IMS client of the non-home network is the same as the current IMS client. If the current IMS client is not supported, the query client may retrieve the IMS client of the non-home network. Accordingly, the user of the mobile terminal may continue to text-message without the loss of service due to incompatible software.

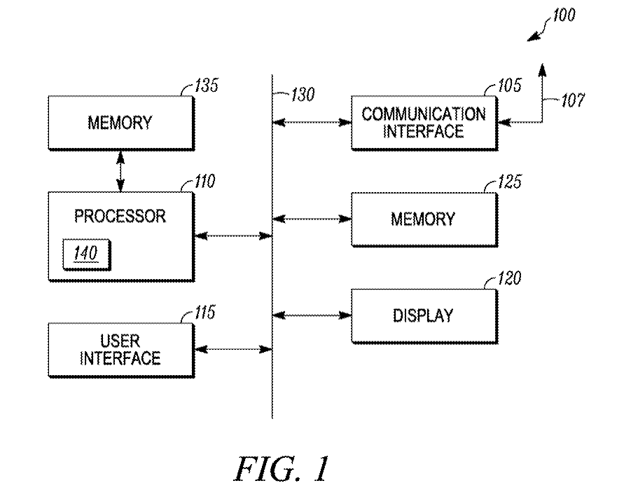

FIG. 1 illustrates an exemplary embodiment of a mobile terminal 100 in accordance with an embodiment. It should be readily apparent to those of ordinary skill in the art that the mobile terminal 100 depicted in FIG. 1 represents a generalized schematic illustration and that other components may be added or existing components may be removed or modified. Moreover, the mobile terminal 100 may be implemented using software components, hardware components, or combinations thereof.

As shown in FIG. 1, the mobile terminal (or mobile client) 100 includes a communication interface 105, a processor 110, a user interface 115, a display module 120, and storage 125. If the communication interface 105 is wireless, it is configured to facilitate communication over an air interface with a base station of a cellular network that supports Internet Messaging Services (“IMS”) services such as the CDMA EV-DO, WiFi or WiMax network. More particularly, the communication interface 105 may transmit and receive digital voice packets through a radio frequency (RF) antenna 107. The communication interface 105 is configured to interface with a shared bus 130. Voice packets to be transmitted may be forwarded from the user interface 115 to the communication interface 105 over the shared bus 130 as well as received voice packets forwarded to the user interface 115 over the shared bus 130.

The processor 110 is configured to interface with the shared bus 130. The processor 110 implements the software that embodies the functionality of the mobile terminal 100, which may be stored in processor memory 135. The processor memory 135 may also or alternately be programmable read only memory, flash memory, or a similar type of high speed persistent storage. The processor 110 may be an application specific integrated circuit, programmable field gate array, a microprocessor, digital signal processor, or similar type of computing platform.

Storage 125 may be configured to store information for a user of the mobile terminal 100. For example, a contact list, music files, and/or digital images may be stored in storage 125. The storage 125 may be implemented using a persistent storage such as flash memory. In some embodiments, the storage function of the processor memory 135 may be provided by storage 125.

In this embodiment, user interface 115 is configured to interface with the shared bus 130. The user interface 115 facilitates interaction with a user. As such, the user interface 115 may include media input and output mechanisms. For example, to facilitate voice communications, these mechanisms may include a microphone (not shown) for receiving analog speech signals from a user and a speaker (not shown) for playing out analog speech signals to a user. Further, the mobile terminal 100 may include digital/analog media signals and digital representations of those signals, for example, a soft button on a keyless display.

The user interface 115 may also include a keypad (not shown). The keypad may be a Bell keypad, a QWERTY keyboard, or similar mechanisms. In some embodiments, the keypad may be emulated on the display 120. The user interface 115 may further include a mechanism or device to initiate services provided by the IMS core of a network.

In accordance with various embodiments, the processor 110 is configured to execute a query client 140. The query client 140 may be a computer program embodiment of functionality for updating the mobile terminal 100 with the network IMS client in accordance with various embodiments. More particularly, the query client 140 may be configured to query a network for the IMS client supported by the network during a session establishment between the network and the mobile terminal 100. If the query client 140 determines that the network IMS client is not the local IMS client executing on the mobile terminal 100, the query client 140 may then retrieve the network IMS client. Alternatively, the mobile terminal 100 may be configured to store multiple IMS clients from various networks in storage 125. As part of the query, the query client 140 may check the stored IMS clients to see if any match the required network IMS client. If there is no match, the query client 140 may be configured to retrieve the network IMS client and discard the stored IMS client with the longest period of inactivity.

In accordance with various embodiments, the query client 140 may monitor whether the mobile terminal enters a non-home network. The query client 140 may then determine whether the IMS client of the non-home network is the same as the current IMS client. If the current IMS client is not supported, the query client 140 may retrieve the IMS client of the non-home network. Accordingly, the user of the mobile terminal 100 may continue to use the application services of the IMS core without the loss of service due to incompatible software.

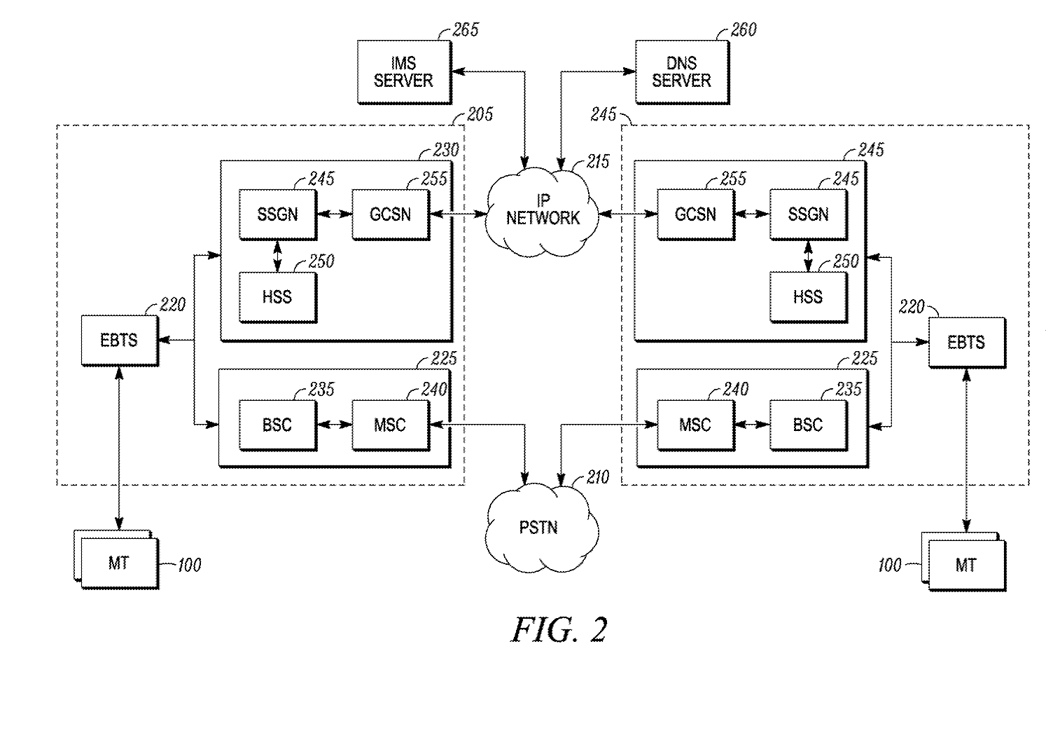

FIG. 2 illustrates an exemplary system 200 in accordance with another embodiment. It should be readily apparent to those of ordinary skill in the art that the system 200 depicted in FIG. 2 represents a generalized schematic illustration and that other components may be added or existing components may be removed or modified. Moreover, the system 200 may be implemented using software components, hardware components, or combinations thereof. In this embodiment, the system 200 includes at least one mobile terminal 100 such as shown in FIG. 1.

As shown in FIG. 2, the system 200 includes access cells 205. The access cells 205 interface with an Internet Protocol (“IP”) network 215. The IP network 215 may be the internet, a private local area network, a private wide area network, or combinations thereof. The IP network 215 may also interface with the public switched telephone network 210 (labeled as PSTN in FIG. 2).

Each access cell 205 includes an enhanced base transceiver station (“EBTS”) 220. The EBTS 220 is configured to transmit and receive voice packets from mobile terminals 100 within the coverage area of the EBTS 220. The EBTS 220 may also include a service integration module (not shown) that is configured to determine the current state of each mobile terminal in the coverage area of the EBTS 220.

The EBTS 220 interfaces with an interconnect call module 225 and a IP call module 230. The interconnect call module 225 includes a base site controller (“BSC”) 235 coupled with a mobile switching center (“MSC”) 240 for handling cellular and circuit switched calls. The MSC 240 may also be interfaced with a home location and visitor location registers (not shown) for providing mobility management as known in the art. The BSC 235 can provide control and concentration functions for one or more EBTS sites and their associated mobile terminals 100.

The IP call module 230 also includes a Serving GPRS Support Node (“SGSN”) 245 interfaced with a home subscriber server (“HSS”) 250 for processing IP calls and packet data. The HSS 250 may also be interfaced with home location and visitor location registers (not shown) for providing mobility management as known in the art. The HSS 250 may also be referred to as visitor location register or home location register. In the case of packet data, the SGSN 245 can route such packet data via a GPRS Gateway Support Node (“GGSN”) 255 to the IP network 215. The

The system 200 may further include a domain name server (“DNS”) 260 and an IMS server 265. The DNS 230 is configured to provide DNS services as known to those skilled in the art. The IMS server 265 is configured to provide the IMS core services for application services between the mobile terminals 100.

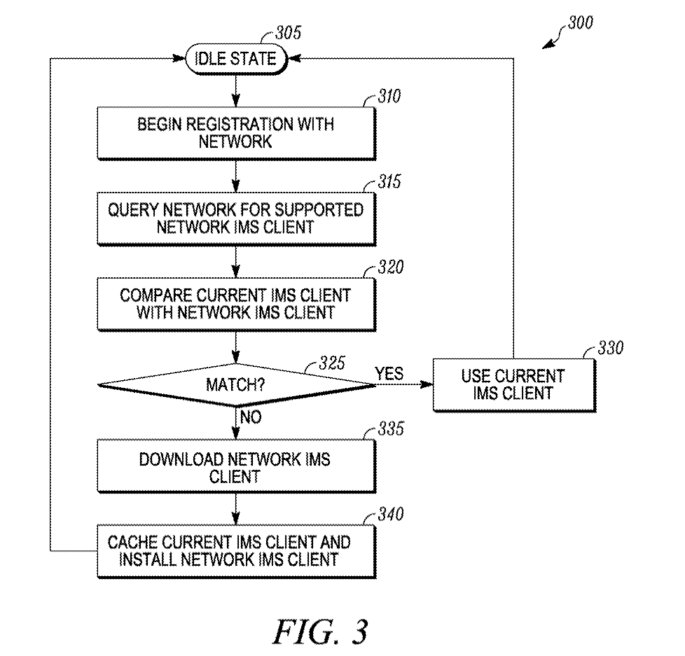

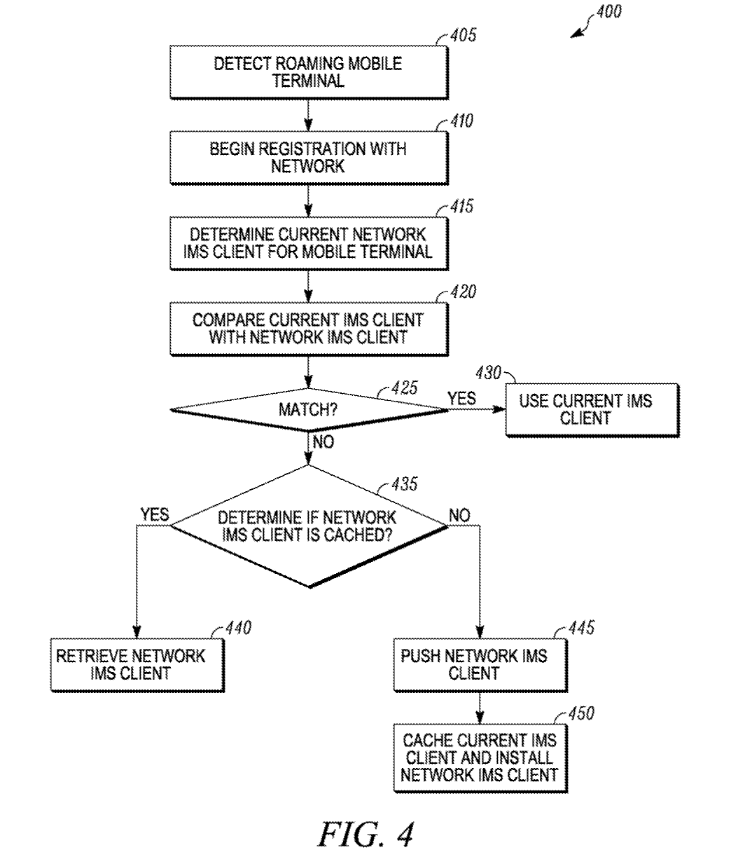

FIG. 3 illustrates a flow diagram 300 implemented by the IMS client 140 in accordance with yet another embodiment. It should be readily apparent to those of ordinary skill in the art that the flow diagram 300 depicted in FIG. 3 represents a generalized schematic illustration and that other steps may be added or existing steps may be removed or modified.

As shown in FIG. 3, the query client 140 may be invoked, in step 305. More specifically, as the mobile terminal 100 is powering on, the query client 140 may be instantiated as part of the normal boot-up procedure for the mobile terminal. Once instantiated, the query client 140 may monitor the mobile terminal 100 to determine whether or not the mobile terminal 100 has started registering with a network (e.g., network 200), in step 310. In various embodiments, the query client 140 may be instantiated and by monitoring whether the mobile terminal has left one service provider and entered an access cell of a second provider. By entering the coverage area of the second provider, the mobile terminal 100 may initiate another registration process that the query client 140 monitors.

The query client 140 may be configured to query the network 200 for the supported network IMS client, in step 315. More specifically, the query client 140 may query the IMS server 265 of the network 200 for the supported network IMS client.

In step 320, the query client 140 may then compare the current IMS client being executed by the mobile terminal 100 in response to receiving an answer to the query issued in step 315.

In various embodiments, the query client 140 may be configured to maintain a list of cached IMS clients. The number of cached IMS clients may be a user determined number or may be dependent on the amount of free memory space in storage 125. The query client 140 may be configured to compare the supported network IMS client against the list of cached IMS clients. This list may be generated as the mobile terminal roams through a geographic area supported by various vendors and/or infrastructure providers.

If there is match in the comparison of the current IMS client and the supported network IMS client, in step 325, the query client 140 may be configured to use the current IMS client currently being executed by the mobile terminal 100, in step 330. Subsequently, the query client 140 returns to the idle state of step 305.

Otherwise, the query client 140 may be configured to download or retrieve the supported network IMS client, in step 335, in response to a non-match between the current IMS client and the supported network IMS client.

The query client 140 may then cache the current IMS client and install the downloaded IMS client as the current IMS client, in step 340. Subsequently, the query client 140 returns to the idle state of step 305.

Certain embodiments may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

What is claimed is:

1. A method of updating, the method comprising:
establishing a session with a network;
determining a network Internet Messaging System (IMS) client of the network; and
retrieving the network IMS client in response to the network IMS client not matching a current IMS client.

2. The method of claim 1, further comprising of using a current IMS client in response to the network IMS client matching the current IMS client.

3. The method of claim 1, further comprising:
searching previously stored IMS clients in response to the network IMS client not matching the current IMS client; and
retrieving a selected previously stored IMS client in response to one of the previously stored IMS clients matching the network IMS client.

4. The method of claim 1, further comprising:
monitoring a current network location area; and
determining a second network IMS client in response to the current location being in a second network.

5. The method of claim 4, further comprising of retrieving the second network IMS client in response to the second network IMS client not matching a current IMS client.

6. The method of claim 4, further comprising:
searching previously stored IMS clients in response to the second network IMS client not matching the current IMS client; and
retrieving a selected previously stored IMS client in response to one of the previously stored IMS clients matching the second network IMS client.

7. An apparatus comprising of means for performing the method of claim 1.

8. A computer-readable medium comprising computer-executable instructions for performing the method of claim 1.

9. A handset comprising:
a network interface configured to receive and transmit signals from a network;
a processor configured to interface with the network interface, wherein the processor is configured to establish a session with the network, determine a network Internet Messaging System (IMS) client of the network; and retrieve the network IMS client in response to the network IMS client not matching a current IMS client for the handset.

10. The handset of claim 9, wherein the processor is further configured to use a current IMS client in response to the network IMS client matching the current IMS client.

11. The handset of claim 9, wherein the processor is further configured to search previously stored IMS clients in response to the network IMS client not matching the current IMS client and retrieve a selected previously stored IMS client in response to one of the previously stored IMS clients matching the network IMS client.

12. The handset of claim 9, wherein the processor is further configured to monitor a current location of the handset and determine a second network IMS client in response to the current location being in a coverage area of a second network.

13. The handset of claim 12, wherein the processor is further configured to retrieve the second network IMS client in response to the second network IMS client not matching a current IMS client.

14. The handset of claim 12, wherein the processor is further configured to search previously stored IMS clients in response to the second network IMS client not matching the current IMS client and retrieve a selected previously stored IMS client in response to one of the previously stored IMS clients matching the second network IMS client.

15. A system comprising:
a network configured to provide communication services for handsets based on a network Internet Messaging System (IMS) client within a coverage area of the network; and
a mobile terminal configured to interface with the network through a network interface, further comprising a processor to establish a session with the network through the network interface, determine a network IMS client of the network; and retrieve the network IMS client in response to the network IMS client not matching a current IMS client for the handset.

16. The system of claim 15, wherein the processor is further configured to use a current IMS client in response to the network IMS client matching the current IMS client.

17. The system of claim 15, wherein the processor is further configured to search previously stored IMS clients in response to the network IMS client not matching the current IMS client and retrieve a selected previously stored IMS client in response to one of the previously stored IMS clients matching the network IMS client.

18. The system of claim 15, wherein the processor is further configured to monitor a current location of the handset and determine a second network IMS client in response to the current location being in a coverage area of a second network.

19. The system of claim 18, wherein the processor is further configured to retrieve the second network IMS client in response to the second network IMS client not matching a current IMS client.

20. The system of claim 18, wherein the processor is further configured to search previously stored IMS clients in response to the second network IMS client not matching the current IMS client and retrieve a selected previously stored IMS client in response to one of the previously stored IMS clients matching the second network IMS client.
